(19) United States
(12) Patent Application Publication
(10) Pub. No.: US 2008/0223844 A1
(43) Pub. Date: Sep. 18, 2008

(54) Textile Based Heating Apparatus and Method

(76) Inventor: Charles E. Cronn, Union, WA (US)

Correspondence Address: K&L Gates LLP, 618 W. Riverside, Suite 300, SPOKANE, WA, 99201-0628, US

(21) Appl. No.: 12/050,083

(22) Filed: Mar. 17, 2008

Related U.S. Application Data
(60) Provisional application No. 60/895,290, filed on Mar. 16, 2007.
(60) Provisional application No. 61/030,807, filed on Feb. 22, 2008.

(51) Int. Cl. H05B 3/36; A41D 19/00; A41B 11/00

(52) U.S. Cl. 219/211; 219/201; 2/160; 29/428; 2/239; 36/43; 36/2.6

(57) ABSTRACT

A heating apparatus comprising a textile based heating element, a power source and related components. The heating apparatus can be designed, retrofitted or manufactured into articles of clothing or equipment such as gloves, vests, jackets, shirts, pants, socks, insoles, mitts, handwarmers, seats and other common articles. A textile based heating element comprises one or more conductive wires stitched into a fabric carrier. Various conductive wire configurations can desirably adjust the resistance of the textile based heating element thereof. Methods of manufacture and use are disclosed in conjunction with the heating apparatus.

### CROSS REFERENCE TO RELATED APPLICATIONS

This application claims the benefit of U.S. provisional application No. 60/895,290 filed Mar. 16, 2007, titled “Textile Based Heating Apparatus” and whose entire contents are hereby incorporated by reference. This application also claims the benefit of U.S. provisional application No. 61/030,807 filed Feb. 22, 2008, titled “Ribbon Based Heating Apparatus And Method” and whose entire contents are hereby incorporated by reference.

### TECHNICAL FIELD

Embodiments of the present invention pertain generally to heating apparatus that can be incorporated into articles of clothing or equipment. More particularly, embodiments of the present invention are directed to the design, manufacture and use of an improved textile based heating element.

### BACKGROUND

While there is a substantial amount of prior art directed at heated clothing and equipment to overcome cold environmental conditions in various applications, few if any of these technologies have been embraced by the marketplaces. Such prior art ranges in concept from gel packets causing exothermic chemical reactions to pre-heated units placed into clothing articles to traditional electric heating devices. More particularly, prior art relating to electric heating devices incorporated into clothing tends to be bulky, heavy and inflexible—thus cumbersome and uncomfortable to wear. It is no surprise that such devices have not been incorporated into everyday clothing and equipment products such as ski gloves, hunting vests or the like.

Typically, such the heating elements found in prior art heated clothing are manufactured using relatively noticeable wiring and inflexible materials (e.g. inflexible wiring of a gauge causing inconvenience). Due to the discomfort and inconvenience of such prior art heating devices, such heating devices are typically only incorporated into clothing or equipment where the critical necessity outweighs the discomfort or inconvenience, (e.g. long term exposure or extreme cold conditions). Even so, such heating devices remain uncomfortable to wear on a regular basis and are prone to fatigue as the heating elements are repeatedly folded, stretched or twisted in the ordinary course of wear and tear.

Similarly, the heating devices industry has also evidenced a lack of technology in providing sufficient portable power supplies given an acceptable weight. As the demand for more heat output or the duration of a given heat output increases, more electric power is required to be supplied from a given electric power source. To date, one of the other reasons that prior art heating devices have not been incorporated in mainstream articles of clothing or equipment, is the limited electric power capacity for their weight. Basically, the quantity of heat generated from the potential electric power stored in prior art batteries simply has not justified the burden of additional weight and inconvenience of the batteries. By way of example, while a snow skier may desire to utilize a pair of heated gloves on a cold day, that skier probably wouldn't be willing to carry around a heavy battery, nor incur the expense of expending a bag full of portable batteries (e.g. alkaline batteries) to keep their body (e.g. fingers, toes, etc.) warm during the course of the day. Thus, it is justifiable, given the lack of technology exhibited in the prior art, why society has evidenced a distinct absence of skiers wearing heated gloves on the slopes. Not unlike the ski community, other communities or activities taking place in cold environments have not witnessed the mainstream acceptance of heated articles of clothing.

Part of this challenge becomes the level of expertise needed to feasibly design and manufacture a heated device having the performance to perform its function, the lightweight and comfort features necessary to be transparent when compared to another article of clothing or equipment, and to be able to be designed, manufactured and supported at a reasonable cost. To design such a new advanced electrically heated article of clothing or equipment, one must become an expert in many fields: material science, electronic wiring and equations, battery designs, power calculations, clothing manufacturing, insulation methods, product safety considerations, textile manufacturing processes as well as other fields. Thus, due to the performance, comfort, cost, support and required talent to be combined into a single product with so many components and variables at play—no heating articles of clothing or equipment have broken into widespread use.

Therefore, an urgent need exists in the clothing and equipment industries to provide a heating apparatus capable of being incorporated into various manufactured articles that is of high performance, minimal bulk, minimal weight, increased flexibility, extended heat generation duration, increased durability and ease of support when compared to the prior art.

Such a heating apparatus would preferably also be capable of being designed, retrofitted and manufactured in a standardized manner. Preferably, such standardized components could also be assembled using common textile industry machines rather than requiring custom fabrication equipment and manual labor as evidenced in the prior art.

### SUMMARY

Embodiments of the present invention are directed toward an improved textile based heating element serving as a standardized heating device that can be incorporated into existing or new articles of clothing and equipment. The improved textile based heating element evidences a significant advancement of heating technology in that embodiments of the present invention (e.g. heated gloves, heated vests, etc.) are virtually indistinguishable in feel, weight and flexibility from ordinary non-heated articles of clothing (e.g. ordinary gloves, ordinary vests, etc.). Further such embodiments, due to the nature and flexibility of the textile based heating element, are capable of significantly longer longevity and durability when compared to prior art heating devices. As such, the incorporation of the textile based heating element heating apparatus into existing and new articles of clothing renders a superior product available to those regularly exposed to cold environmental conditions.

Other embodiments of the present invention are directed toward standard heating elements comprising one or more textile based heating elements that can be incorporated on a modular basis into various articles of clothing or equipment. By way of example, one or more 7 volt heating elements can be placed into a glove, a vest, pants, garment system or other articles of clothing or equipment, all utilizing a standard power source designed for use in conjunction with the 7 volt heating elements.

Further embodiments of the present invention are directed toward the method of design and manufacture of such a heating apparatus and textile based heating element.

Various options and approaches of embodiments of the invention are also discussed throughout the technical disclosure, including additional components, characteristics and aspects that enhance the performance of various embodiments. It is understood that while heated articles of clothing (e.g. gloves, vests) and heated articles of equipment (e.g. sporting goods, vehicle components) are exemplary applications used to describe specific details of a best mode of practice of the invention, the presently disclosed invention contemplates other embodiments not necessarily disclosed within the confines of the present examples.

### BRIEF DESCRIPTION OF THE DRAWINGS

Embodiments of the invention are illustrated by way of example, and not by way of limitation, in the figures of the accompanying drawings and in which like reference numerals refer to similar elements, wherein:

FIG. 1 is a top view of a textile based heating apparatus within a heated glove according to an embodiment of the invention.

FIG. 2 is a top view of a textile based heating apparatus according to an embodiment of the invention.

FIG. 3A is a top view of a textile based heating element comprising of eight conductive wires according to an embodiment of the invention.

FIG. 3B is a top view of a textile based heating element comprising of four conductive wires according to an embodiment of the invention.

FIG. 3C is a top view of a textile based heating element comprising of eight conductive wires according to an embodiment of the invention.

FIG. 3D is a top view of a textile based heating element comprising of according to an embodiment of the invention.

FIG. 4A is a top view of a seven volt textile based heating element according to an embodiment of the invention.

FIG. 4B is a top view of a twelve volt textile based heating element according to an embodiment of the invention.

FIG. 5A is a top view of a twelve volt textile based heating element according to an embodiment of the invention.

FIG. 5B is a top view of a seven volt textile based heating element according to an embodiment of the invention.

FIG. 6A is a cross section view illustrating the layers of a textile based heating element according to an embodiment of the invention.

FIG. 6B is a cross section view illustrating the layers of a textile based heating element according to an embodiment of the invention.

FIG. 7A is a cross section view illustrating the layers of a heated glove according to an embodiment of the invention.

FIG. 7B is a close-up partial cross section view illustrating the layers of a heated glove according to an embodiment of the invention.

FIG. 8 is a cut-away top view of a heated footbed article according to an embodiment of the invention.

FIG. 9A is a perspective view of a heated sock according to an embodiment of the invention.

FIG. 9B is a perspective view of a heated sock according to an embodiment of the invention.

FIG. 10 is a front view of a heated jacket according to an embodiment of the invention.

FIG. 11 is a front view of a heated clothing system and a plurality of articles of heated clothing according to an embodiment of the invention.

FIG. 12A is a top view of a heated mitt according to an embodiment of the invention.

FIG. 12B is a top view of a heated handwarmer according to an embodiment of the invention.

FIG. 13A is a perspective view of a heated seat on an all terrain vehicle.

FIG. 13B is a close-up perspective view of a heated seat for an all terrain vehicle.

### DETAILED DESCRIPTION OF PREFERRED EMBODIMENTS

In the following description, for the purposes of explanation, specific details are set forth in order to provide a thorough understanding of the invention. However, it will be apparent that the invention may be practiced without these specific details. In other instances, well-known structures and devices may be depicted in block diagram form in order to avoid unnecessary obscuring of the invention. Section titles and references appearing within the following paragraphs are intended for the convenience of the reader and should not be interpreted to restrict the scope of the information presented at any given location.

Various aspects and features of example embodiments of the invention are described in more detail hereinafter in the following sections: (i) Functional Overview, (ii) Textile Based Heating Element, (iii) Constructing A Textile Based Heating Element, (iv) Self Fusing Characteristics (v) Environmental And Electrical Insulation, (vi) Applications Of A Textile Based Heating Element and (vii) Conclusion.

### FUNCTIONAL OVERVIEW

The improved textile based heating element heating apparatus disclosed in the present technical disclosure solves various aforementioned shortcomings and problems posed by the prior art. More particularly, heated articles (e.g. gloves, clothing, seats, etc.) incorporating (e.g. retrofitting, manufacturing or placing) the improved textile based heating apparatus evidence one or more of the advantages of light weight, flexibility, comfort, durability, longevity, efficiency of manufacture and ease of support not found in the prior art.

For the purposes of the present disclosure, various embodiments directed toward heating apparatus will be discussed at length. However, such discussion should not be construed to limit the scope of the present disclosure and present invention to only heated apparatus. It is noted that the textile based heating element, while described herein for heating purposes, can also be utilized in a number of other embodiments ranging from power transmission functions or data transmission applications.

At the core level of theory, embodiments of the present invention primarily comprise a textile based heating element wherein electricity is transmitted through the textile based heating element thereby generating heat. Such a textile based heating element namely comprises of one or more conductive wires allowing the transmission of electricity and the generation of heat. Typically, the one or more conductive wires are woven, embroidered, stitched or otherwise impregnated into a carrier fabric. The flexible textile based heating element can be utilized in the manufacture of heated articles, such as heated articles of clothing (e.g. gloves, shirts, pants, socks, shoes, hats, uniforms, etc.) or heated articles of equipment (e.g. sports mitts, sports hand warmers, portable seat pads, vehicle seats, etc.). The flexible transmission element can also be utilized for other purposes, as desired, for the manufacture of articles of clothing or articles of equipment for the transmission of data rather than heat generation.

The term “conductive wires” or “wires” is used to define not just a commonly known conductive wire, (e.g. metallic wire such as stainless steel), but also any textile yarn or other material that is manufactured, impregnated or otherwise contains a conductive or semi-conductive material capable of conducting electricity across the length of the conductive wire. For example, the one or more conductive wires in preferred embodiments can be comprised of a textile based yarn (e.g. nylon, polyester, cotton, etc.) comprising of some conductive or semi-conductive material infused into the yarn. The conductive or semi-conductive material used can be of copper, nickel, silver or other known conductive or semi-conductive material. Such textile based yarns comprising of a conductive or semi-conductive material are preferable in that these yarns can be manipulated and utilized in industry standard textile and embroidery machines.

While a fully metallic wire (e.g. stainless steel) can also be used, it is typically not flexible nor durable enough to run through industry standard textile and embroidery machines. To the extent such a wholly metallic wire can be designed and manufactured to endure typical textile industry manufacturing stresses, such materials can also be considered a preferred conductive wire.

The one or more yarns are preferably stitched into or embroidered into the fabric carrier where desired to form a textile based heating element. While the conductive wires could also be woven into the fabric carrier, this would require that the conductive wire be placed into the carrier fabric at a significantly earlier stage than a later stitching or embroidery of an already manufactured fabric carrier.

Typically, a heating element, together with its fabric carrier, is then preferably treated with one or more environmentally resistant coatings such as plastic, vinyl or other protective materials. Such a coating can be applied in a number of different processes, namely dipping the heating element and its fabric carrier into a liquid coating, spraying the coating onto the heating element, or other conventional methods to create a physical and environmental barrier between the heating element and the environment.

A textile based heating element and any related components thereof (e.g. conduit, power supply, etc.) constitute a heating apparatus. In preferred embodiments designed for the generation of heat, electricity is transmitted through the conductive wires through the length of the textile based heating element. The design and length of the heating element can be determined and standardized to match a suitable power source, thereby optimizing performance of the heating apparatus. Various wiring schemes can be utilized to optimize the resistance of the textile based heating element to match the power source voltage. Control mechanisms configured within or in conjunction with the power source can also be utilized to selectively control the amount of electricity transmitted through the textile based heating element.

The manufacturing process of the textile based heating element and heating apparatus also represents a significant advancement of the art, as heating apparatus can be manufactured in a standardized, simplified process not yet witnessed in the art. For application into articles of clothing or equipment, whether a retrofit or a new article, the textile based heating element and related components are thereafter sandwiched, sewn, attached or otherwise incorporated into the existing physical structure of the article. As preferred embodiments utilize standardized heating elements and power sources, if a textile based heating element or other component fails, the failed component can be readily replaced with a like standard unit.

A comprehensive and detailed examination of preferred embodiments of the present invention will now be addressed in the following sections, namely discussion of textile based heating elements, power sources, heating apparatus, heated articles and the manufacture thereof.

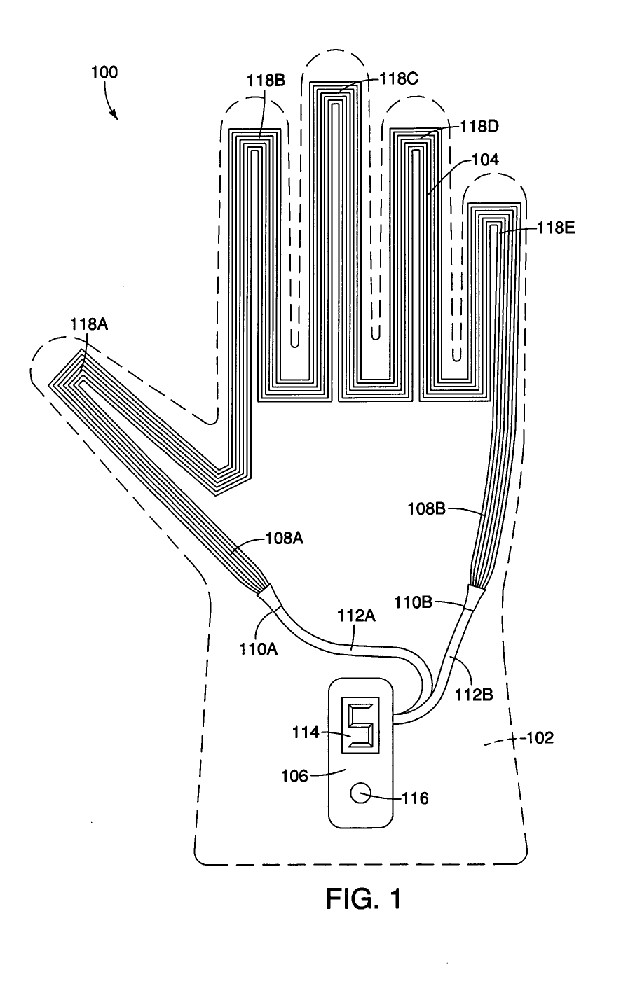

FIG. 1 is a illustration of a heating apparatus 100, namely a textile based heating element 104 having one or more conductive wires (e.g. seven wires as shown) coupled to a power source 106. As illustrated, the heating apparatus 100 is stitched into a fabric carrier 102 such as the shape of a glove. Such a fabric carrier can be an inner liner of a glove if desirable. A first end 108A of the heating element 104 is electrically coupled to a conduit 112A utilizing a connector 110A, and a second end 108B of the heating element 104 is coupled to a conduit 112B utilizing a connector 110B. Conduits 112A and 112B are electrically coupled to power source 106, thereby providing electronic communication between power source 106 and heating element 104.

More particularly, in the configuration illustrated the one or more conductive wires of the heating element 104 are stitched into the fabric carrier 102 along the top of each of the fingers 118B through 118E and thumb 118A of the fabric carrier 102. Typically, such designs are pre-programmed into a stitching machine (e.g. an embroidery system) and the stitching machine therefore creates one or more conductive wires of the heating element 104 upon the fabric carrier 102.

In preferred embodiments, the power source 106 further comprises a switch 116 (such as a pushbutton as illustrated) to control the transmission of electricity through textile based heating element 104. Any conventional switch technology or electrical limitation device (e.g. sliding switches, rotary switches, digital switches, timer switches, diodes, etc.) can be utilized for switch 116 to provide a desired constant, pulsed or periodic, variable or non-variable, transmission of electricity to the textile based heating element 104.

Power source 106 can also be configured to comprise a meter 114 (such as an LED illuminated number as illustrated) to indicate the status of the availability of power in the power source, the status of the amount of electricity being transmitted or other desired information to the user of the heating apparatus. For example, as illustrated by meter 114, the number “5” can be configured to indicate a remaining power available of 50%. If desired, such a “5” can also be configured to indicate a power setting (amount of transmission of electricity) of 5 on a given scale relating to a variable power setting.

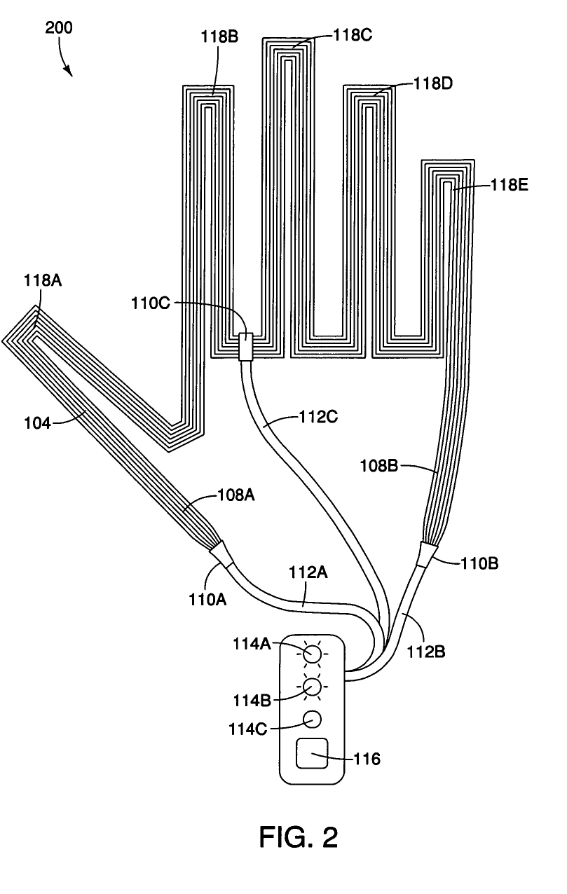

Turning to FIG. 2, an alternate heating apparatus 200 is illustrated, somewhat similar to the heating apparatus 100 in FIG. 1 in various components wherein the fabric carrier 102 is omitted. However, the heating apparatus 200 evidences an alternate metering configuration comprising of a first meter 114A, a second meter 114B and a third meter 114C. As depicted, first meter 114A and second meter 114B are illuminated whereas third meter 114C is not illuminated. Depending upon the desired application, meters 114A, 114B and 114C can be configured to convey the power availability (e.g. battery at ⅔ power), the amount of electricity being transmitted through the textile based heating element 104 (e.g. the current heat setting) or other pertinent information to the user of the heating apparatus 200. Each of the meters 114A, 114B and 114C can also be configured to represent independent information (e.g. power on status, power left status, power charging status, etc.)

Additionally, as illustrated a third connector 110C can be coupled to and electrically communicate with the one or more conductive wires 104 between the finger 118B and finger 118C. The third connector 110C is thereby coupled and in electrical communication with a third conduit 112C leading to the power source 106. In such an embodiment, electricity can instead be supplied to conduits 112A and 112B and therein return through conduit 112C acting as a ground (back to the power supply 106). This provides two shorter circuits for the one or more conductive wires 104 rather than a single, longer circuit as depicted by FIG. 1. Such alternate wiring schemes are helpful for the design and configuration of various embodiments of the heating apparatus.

Thus having provided a brief primer of a preferred heating apparatus, the present disclosure will now examine further aspects of the textile based heating element, the power source and related elements and manufacture thereof in greater detail.

### TEXTILE BASED HEATING ELEMENT

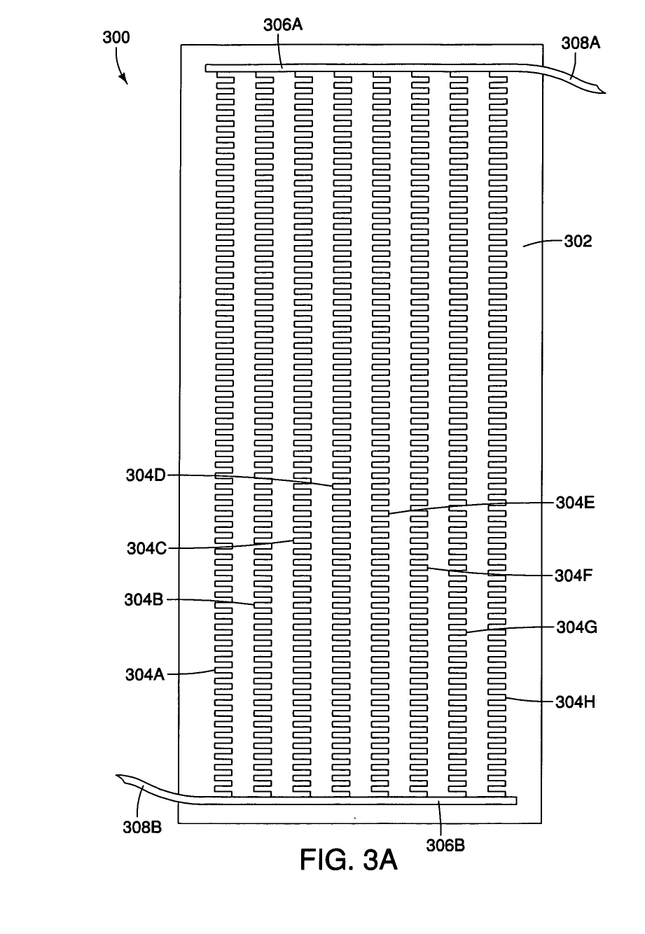

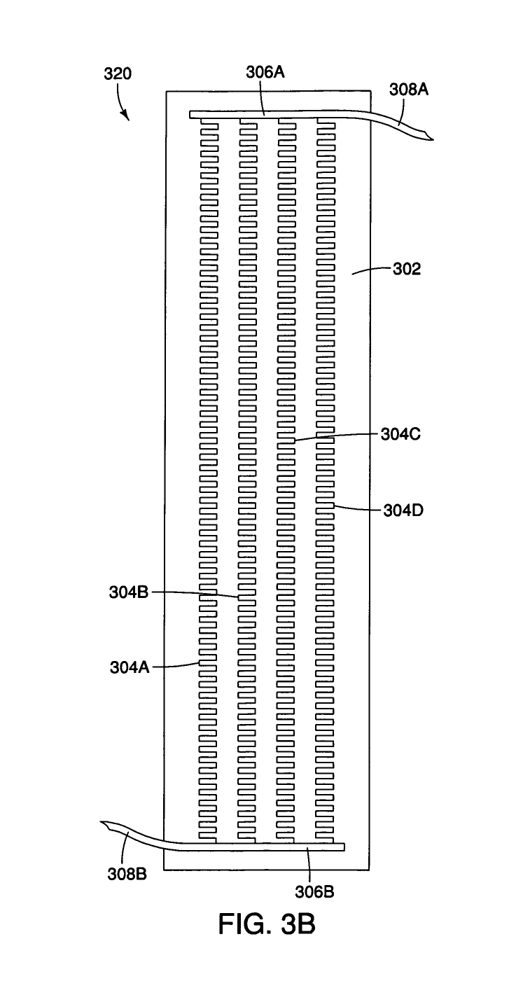

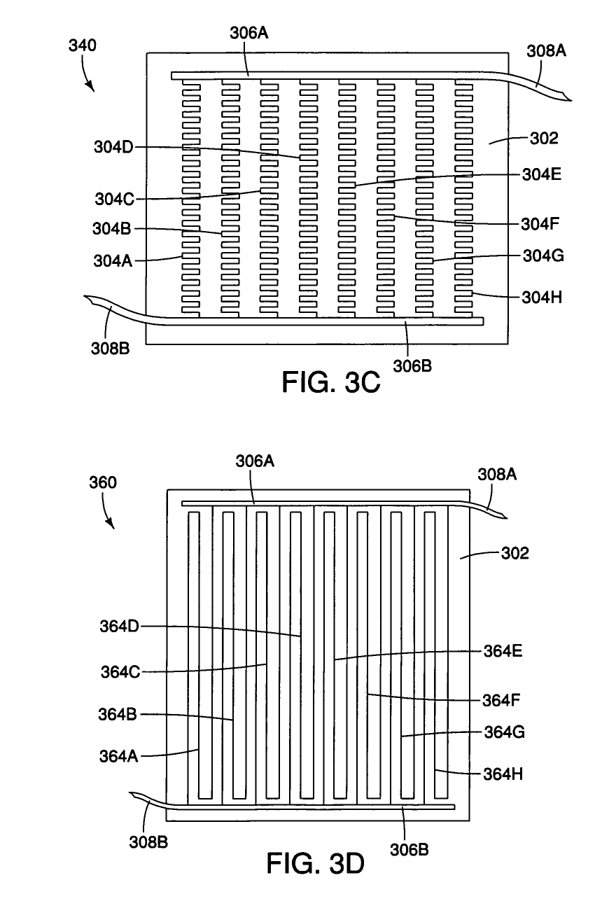

FIG. 3A illustrates a textile based heating element 300 having eight conductive wires 304A through 304H. The conductive wires are stitched into fabric carrier 302. Fabric carrier 302 could be a portion of an inner liner of a clothing article such as the inner lining of a glove or vest (not shown) or an inner layer of a piece of equipment such as the inner liner of a seat cushion (not shown).

It is preferable that fabric carrier 302 comprise a flexible and durable material, such as nylon, polyester, cotton or other textile fabric. Moreover, it is advisable to use a material for fabric carrier 302 that is capable of being manipulated by textile industry standard machines.

Conductive wires 304A through 304H are each coupled to terminal 306A and terminal 306B, wherein each of the conductive wires have electrical communication with terminals 306A and 306B. Terminals 306A and 306B are coupled and have electrical communication with conduit 308A and conduit 308B, respectively. Conduits 308A and 308B lead to a power supply (not shown) suitable for providing electrical power which thereby provides heat generation within the heating element 300.

While embodiments of the present invention as disclosed reflect that conductive wires have been stitched into a fabric carrier resulting in a pattern of one or more conductive wires 304A through 304H, it is possible to fabricate a textile based heating element 300 in other configurations such as sandwiching the conductive wires 304A through 304H between two fabric carriers (not shown), adhering the conductive wires to one face of the fabric carrier (not shown) or other methods. Stitching conductive wires into a fabric carrier (as depicted by textile based heating element 300) has been found to be preferable over such other means of forming a textile based heating element 300, though other such methods of securing one or more conductive wires to a fabric carrier (e.g. adhesive, sandwiching, etc.) can be considered as equivalent to “stitching”. In that regard, a textile based heating element having one or more conductive wires stitched, embroidered, impregnated, woven, attached, glued or otherwise secured to a fabric carrier is broadly construed as having the conductive wires “stitched” into the fabric carrier.

Turning to FIG. 3B, a textile based heating element 320 similar to the textile based heating element 300 of FIG. 3A is illustrated, comprising of similar components. However, rather than having eight conductive wires 304A through 304H in the heating element 300, heating element 320 has four conductive wires 304A through 304D. Similar to conductive wires 304A through 304H being wired in a parallel circuit between terminals 306A and 306B in heating element 300 in FIG. 3A, conductive wires 304A through 304D in heating element 320 are configured in a parallel circuit between terminal 306A and terminal 306B in FIG. 3B as well.

Since heating element 320 only has four conductive wires 304A through 304D rather than eight conductive wires 304A through 304H of heating element 300, the electrical resistance of heating element 320 would be higher than the electrical resistance of heating element 300, (assuming all other attributes are equal).

Turning to FIG. 3C, a textile based heating element 340 similar to the textile based heating element 300 of FIG. 3A is also illustrated, comprising of similar components. However, as illustrated the length of the eight conductive wires 304A through 304H in the heating element 340 are relatively shorter than the eight conductive wires 304A through 304H of heating element 300. As such, the electrical resistance of heating element 340 would be lower than the electrical resistance heating element 300, (assuming all other attributes being equal).

While the heating elements 300, 320 and 340 reflect a somewhat square sinalusoidal block pattern, other stitching designs are equally as effective and desirable. Turning to FIG. 3D, an alternate textile based heating element 360 is illustrated, comprising of similar components to the heating element 340 of FIG. 3C. However, eight conductive wires 364A through 364H are illustrated as having an alternate stitching pattern that passes back and forth between terminals 306A and 306B rather than a square sinusoidal block pattern.

In some applications such as an article of clothing or seat cushion, there can be a high degree of linear stress on the conductive wires, terminals and conduits. Typically, such terminals 306A and 306B can be configured from braided copper that is securely stitched to the fabric carrier 302 such that electrical communication with conductive wires 304A through 304H is secure. Similarly, it is recommended to utilize sturdy and secure connective methods (e.g. crimping devices, solder, etc.) to couple the terminals 306A and 306B to conduits 308A and 308B.

Alternatively, one can implement a seamless (braised) butt splice electrical connector. To do so, the conductive wires are extracted or stripped from the fabric carrier and optionally twisted together. The conductive wires are then placed in the end of such a splice connector and mechanically crimped in place. This method secures the bundles of fibers and provides excellent electrical communication. Other methods such as spot welding and electrical resistance brazing may also be employed to create the connection and electrical communication to the conductive wires.

Typically, electricity is transmitted through all conductive wires in a given textile based heating element similar to the configuration of textile based heating elements 300, 320, 340 and 360 in FIGS. 3A, 3B, 3C and 3D, respectively. In such a configuration, the conductive wires 304A through 304H are all utilized as a parallel circuit of a given textile based heating element.

Since the number of conductive wires is different between the textile based heating elements 300, 320, 340 and 360 in FIGS. 3A, 3B, 3C and 3D, respectively, each of the textile based heating elements 300, 320, 340 and 360 evidence different electrical properties (e.g. resistance, minimum and maximum recommended current and other attributes). Such considerations significantly affect the design and manufacture of an apparatus where either an optimal current or a constant current is desired. As the resistance of a given textile based heating element affects the electric current through the textile based heating element and heat generated by the textile based heating element, it is a significant consideration to consider the number of conductive wires in the textile based heating element, the length of the conductive wires in the textile based heating element circuit and voltage of the power source when designing and manufacturing a heating apparatus for an article of clothing or article of equipment.

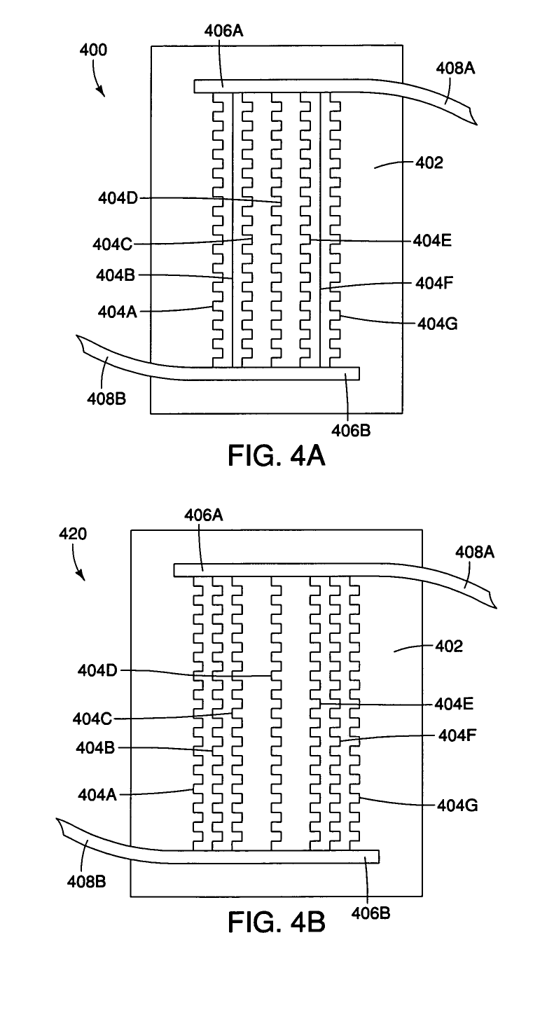

As noted above, certain configurations, patterns and wiring schemes of the textile based heating element can also aid in optimizing an embodiment of the presently disclosed invention. Turning to FIG. 4A, a seven volt version of a heating element 400 of approximate size of eleven inches by six inches is illustrated, having seven conductive wires 404A through 404G in electrical communication with terminals 406A and 406B. Terminals 406A and 406B are in electrical communication with conduits 408A and 408B which are electrically coupled to a power source (not shown). The seven conductive wires 404A through 404G are stitched into fabric carrier 402, providing physical structure and electrical insulation between conductive wires 404A through 404G for the heating element 400.

It is further noted that as illustrated conductive wire 404B and conductive wire 404F are somewhat straight lines and do not comprise the somewhat square sinusoidal block pattern of the remaining conductive wires 404A, 404C, 404D, 404E and 404G. Such variations in the pattern of certain conductive wires can be desirable as the electrical resistance of the individual conductive wires is therefore different. Such differences in electrical resistance can optimize the heating element 400 when used under variable power settings of a power supply (not shown).

Turning to FIG. 4B, a twelve volt heating element 420 of similar size of eleven inches by six inches is illustrated having some similar characteristics and components to heating element 400. As depicted, conductive wires 424A through 424G are in electrical communication with terminals 406A and 406B and are not equally spaced across the heating element 420. In the embodiment illustrated, more heat would be generated in the left and right portions of the heating element 420, whereas less heat would be generated in the middle of the heating element 420.

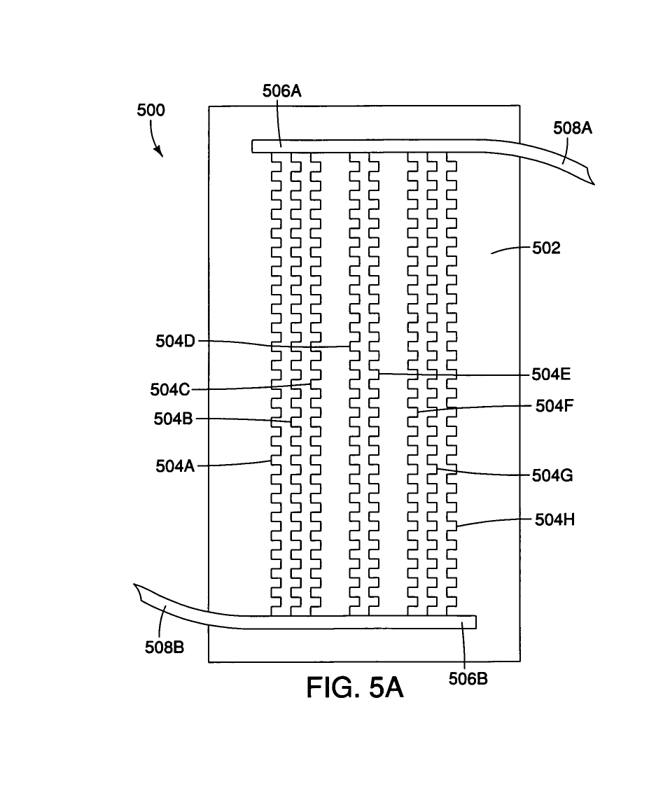

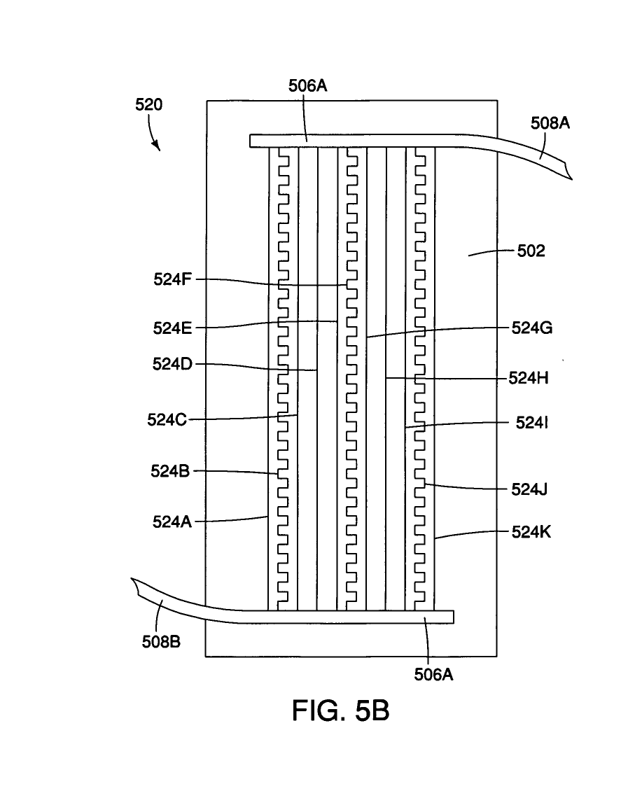

Turning to FIG. 5A, a seven volt version of a heating element 500 of approximate size of ten inches by five inches is illustrated, having eight conductive wires 504A through 504H in electrical communication with terminals 506A and 506B. Terminals 506A and 506B are in electrical communication with conduits 508A and 508B which are electrically coupled to a power source (not shown). The eight conductive wires 504A through 504H are stitched into fabric carrier 502, providing physical structure and electrical insulation between conductive wires 504A through 504H for the heating element 400. Such a heating element 500 typically has an electrical resistance from 6 to 7 ohms. When coupled to a suitable power supply (not shown), the heating element 500 conducts roughly 1.0 to 1.25 amperes at 7VDC.

Turning to FIG. 5B, a twelve volt heating element 520 of similar size is illustrated similar to heating element 500. As depicted, conductive wires 524A through 524K are in electrical communication with terminals 506A and 506B. Such a heating element 520 typically has an electrical resistance from 10.5 to 12 ohms. When coupled to a suitable power supply (not shown), the heating element 520 conducts roughly 0.85 to 1.15 amperes at 12VDC,

In preferred embodiments, it is further advisable to configure a sensor (not illustrated) to automatically shut off the power supply under unsafe conditions. Such a sensor could be configured, as in current prototypes, to shut off the power supply when a temperature of 110 degrees is reached. Alternatively, such a sensor could also serve as a control to adjust the power output of the power source on a continuous basis. However, it is noted that a typical desirable feature of the textile based heating apparatus is the ability to self destruct if an unsafe overheating condition occurs, (see section below titled “Self Fusing Characteristics”).

As noted throughout the technical disclosure, diverse functions (e.g. heat generation, power transport or data transmission, etc.) can be performed by transmission of electricity through the textile based heating element disclosed above. For purposes of describing a single best mode of practice under patent laws, various forms of apparatus for heat generation will be discussed in the following sections, which in no way should be construed to limit the scope of the foregoing invention to that of only heat generation.

### CONSTRUCTING A TEXTILE BASED HEATING ELEMENT

As noted above, a given textile based heating element is typically created by stitching conductive yarn into a fabric carrier such as an inner liner of an article of clothing or article of equipment. The conductive yarn utilized can range from metallic fibers to polymer coated fibers of various electrical characteristics. Our research to date has found that conductive yarn made from a textile based fiber type material are preferable to metallic wires, as they are more durable during the manufacture of the heating element. Most preferred embodiments to date consist of a base nylon thread stock that has been chemically bonded with metal. This creates a base material that is not only very electrically conductive, but is capable of being processed by standard textile manufacturing equipment. Preliminary testing shows that most material remains electrically stable over more than a dozen washing cycles. Once the conductive yarn is stitched into the fabric carrier in a desired design, conductive wires are formed in the fabric carrier forming a heating element.

With respect to the fabric carrier (or also called a “substrate”) various heating elements have been successfully fabricated on a variety of fabric carriers. For example, heating elements have been successfully stitched into non-woven materials, nylon taffeta, polyester fleece and a variety of other materials with equal success. Some materials lend themselves to fabric carrier manufacture more readily than others. Namely, this is due to the stitching process that produces the heating elements (automated embroidery equipment or other stitching equipment) and also due to the fact that some materials allow for better thermal and/or electrical insulation properties. The selection of a fabric carrier material should take such factors into account, along with the end use of the heating apparatus in a clothing or equipment article.

In particular, it has been found that single-sided polyester fleece is a preferable material to serve as a fabric carrier because it hinders the loss of heat and when stitched the heating apparatus has a three-dimensional structure that helps to keep the conductors electrically insulated from each other. However, some non-woven materials also work well when building laminated structures.

Regarding the construction of a terminal (or otherwise referred to as a “power bus”), it has been found that tin plated and bare flat braded copper conductors are suitable to be stitched onto the fabric carrier over a portion of a conductive wire. It is further preferable to use a conductive or semi-conductive yarn or thread to stitch the terminal to the conductive wire and fabric carrier.

Typically as to process for a reliable electrical communication between the conductive wire and a terminal, a conductive wire is first stitched into the fabric carrier. Thereafter, the terminal is placed over the conductive wire and a second stitching secures the terminal to the conductive wire. A portion at the end of the terminal is typically left available for an electrical connector to attach (this completing an electrical communication to a conduit, power supply, etc.).

When designing the pattern of conductive wires for a heating element to be incorporated in a heating apparatus, the design phase commences with selecting the size of the heating element and the electrical and thermal properties of the heating apparatus. Such properties will principally dictate a length, number and pattern of conductive wires, which are typically drawn and designed on a computer software.

The computer software, in conjunction with a stitching machine, then stitches one or more conductive wires into one or more sample fabric carriers to form one or more prototypes for testing. Once one or more prototypes reliably meet the desired tolerances for manufacture, the design is then manufactured in a quantity desired. Such a computer-aided design method typically results in a fairly short period from concept to design to manufacturing capabilities.

As noted above, various characteristics can be manipulated for a given heating element (number of conductive wires, length of conductive wires, conductivity of conductive wires, wiring schema, etc.) to attain desirable characteristics. However, during manufacture, other characteristics not disclosed above can also be manipulated further refine such a design, such as differing the stitch patterns. For example, even different areas of the same heating element can have different conductive wire densities by combining a non-linear stitch pattern (zig-zag, square sinusoidal block, smooth sinusoidal, triangular, etc.) with a straight pattern. This allows the unit to dissipate more power where the linear paths have less length compared to the longer paths of the differing stitch pattern.

Fabrication times for a standard twelve volt heating element measuring twelve inches by eight inches is approximately five to seven minutes using a single head stitching machine. Using a multi head stitching machine can increase the production rates per operator dramatically.

The electrical and thermal performance of a heating element fabricated similar to that above is typically preferable over the prior art. The conductive wires and heating element generally have a low surface area and high average temperature. This facilitates thermal transfer between where the heat is generated and the object to be heated. The design and fabrication process provides a large amount of flexibility in determining the number and spacing of conductive wires thus providing the ability to tune the heating assembly to maintain safety while maximizing heat transfer.

Moreover, the method described above typically yields a heating apparatus that behaves more like a carbon fiber heating panel system. Carbon fiber does produce high performance panels that are able to transfer their heat effectively to the object to be heated. However, the problems inherent in using carbon fiber are not present in the present invention, namely textile based heating elements are not prone to shedding or fracturing of the fragile carbon fibers due to shear forces.

Heating elements as disclosed are typically designed and manufactured with multiple conductive wires wired in a parallel manner. This practice provides for some redundancy in the heating element. If one of the individual conductive wires should break it will have only a small effect on overall heat output of the heating element. For example, on FIG. 3A, eight conductive wires 304A through 304H are illustrated. If one or two of the conductive wires 304A through 304H were to break or be disabled, (e.g. particularly one in the middle such as 304D, etc.), this would not substantially alter the performance or operation of the heating element.

### SELF FUSING CHARACTERISTICS

One of several advantages of the presently disclosed embodiments relates to a self fusing characteristic of the heating elements at high temperatures. Traditional materials used in prior art heating systems can reach very high temperatures for a sustained period before such devices fail and break the electrical circuit. Standard wires utilized in prior art heating systems can reach very high temperatures, (e.g. well over 400 degrees Fahrenheit), as well as silicone based polymer materials. For example, nylon can exceed 400 degrees Fahrenheit before melting, but this transition can happen quite quickly due to the low thermal mass of the nylon fiber itself.

However, conductive wires in embodiments of the presently disclosed heating elements can readily be designed and fabricated to “self fuse” thus eliminating the conductivity of a given conductive wire once a moderate temperature (e.g. 150 degrees Fahrenheit) is reached. These temperatures provide a much safer product to be worn on the body or put into equipment—far lower failure temperatures than that found in the prior art.

### ENVIROMENTAL AND ELECTRICAL INSULATION

Due to environmental and electrical vulnerabilities of typical conductive materials used in conductive wires of the presently disclosed embodiments, it is recommended that one or more coatings be applied to a heating element to make it more resistant to such vulnerabilities.

Various methods have been developed that seal out air and moisture from the fabricated structures. Lamination and impregnation have been utilized as effective means to protect conductive wire and fabric carrier from air, water, temperature, oxidation, electrical charge and other environmental vulnerabilities. More particularly, impregnation of the heating element with plastic compounds and sealing the heating element in a plastic minimizes a change of resistance in the heating element due to diverse environmental conditions.

Typically impregnation of a heating element in a liquid plastic such as Plastisol is preferable. A tank of such liquid plastic should be regularly mechanically stirred or agitated until there are no solids in the tank. Before coating a heating element with a coating such as a liquid plastic, the heating element should be flattened and preferably pressed. Teflon sheets can be used on each side of the fabric carrier to prevent the heating element from sticking to such a pressing device.

Typically, if using a product such as a liquid plastic (e.g. Plastisol) the temperature in the dipping tank should be set to roughly 350 degrees Fahrenheit. The heating element can be dipped into a portion of liquid plastic, easily being manipulated by ends of the terminals protruding from the heating element. The heating element can be clipped or hung above the tank of liquid plastic so that excess liquid plastic drips back into the tank for roughly two minutes.

After hanging for a few minutes, the heating element should be placed back into the heating press (preferably between Teflon sheets) and again pressed for roughly two minutes at roughly 350 degrees Fahrenheit. This evenly distributes and impregnates the liquid plastic into the fabric carrier. Once the heating element cools to 120 degrees Fahrenheit or less, typically the Teflon sheets will be easier to remove from the heating element.

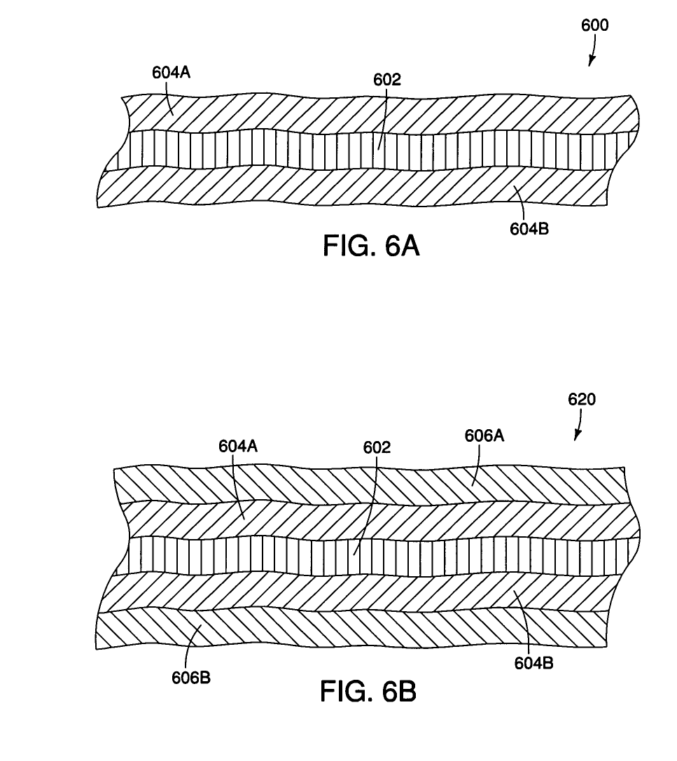

In FIG. 6A, the various layers of a heating element 600 are illustrated, namely a fabric carrier 602 layer (with conductive wires not shown therein), along with exterior liquid plastic layers 604A and 604B.

In yet other embodiments, alternatively a vinyl sheet can be secured to a heating element, whether or not liquid plastic has been applied beforehand. Such a vinyl sheet provides further environmental protection that in some conditions is superior to the liquid plastic treatment described above. In preferred embodiments where extreme environmental conditions are expected, (e.g. marine environments), it is further advantageous to utilize the liquid plastic coating first, followed by a vinyl coating thereafter.

Turning to FIG. 6B, the layers of preferred embodiment of a heating element 620 are illustrated, namely a fabric carrier layer 602 (with conductive wires not shown therein), liquid plastic layers 604A and 604B and vinyl layers 606A and 606B. Of course, while the term “vinyl” is used, any other durable coating or sheet can equally be applied with success as well.

Having described the basic functionality, design and manufacture of a heating element, various applications for the heating element and heating apparatus thereof will now be discussed.

### APPLICATIONS OF A TEXTILE BASED HEATING ELEMENT

While only certain examples of embodiments are discussed in detail below for brevity, there remains a diverse landscape of embodiments anticipated by the present invention. Therefore, it is further understood that the following examples are not limiting by nature, but rather specific examples where the disclosed apparatus can be applied to solve a problem or create an improved product.

While a number of heated articles of clothing or heated articles of equipment are capable of design and manufacture utilizing textile based heating element designs, only a few of many are disclosed herein for brevity.

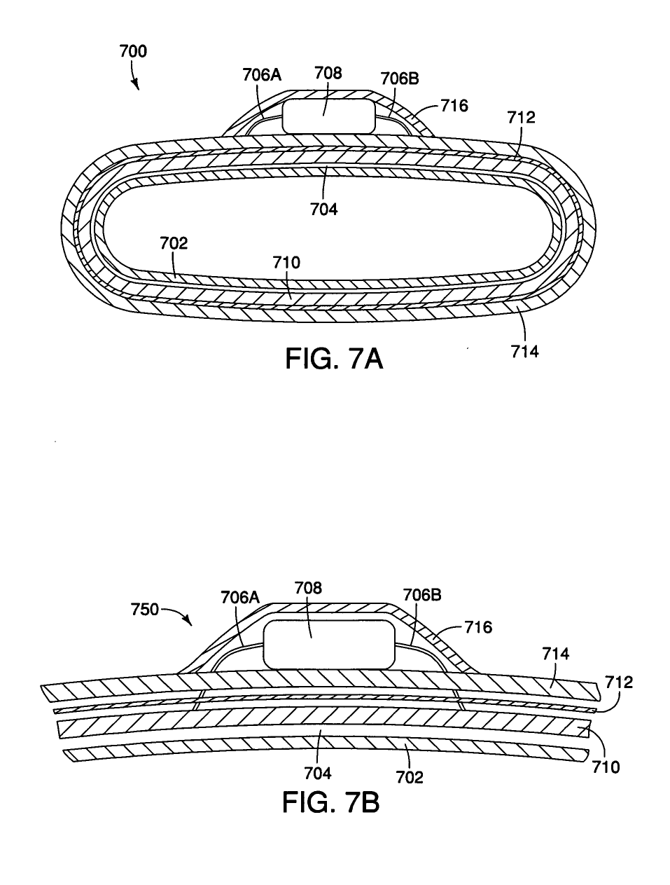

FIGS. 7A and 7B illustrate by way of example the structure of a heated glove. The primary structural component is an ordinary cold weather glove such as a ski glove or a hunting glove. The disclosed heating apparatus can be installed into any glove design and once configured properly is substantially transparent to the end user. Various type of textile materials (from nylon to fleece to leather) have been tested, along with most types of glove construction (straight cut palm, gun cut, etc.) with similar successful results.

FIG. 7A is a cross section view of a heated glove 700. Such a heated glove 700 can be manufactured from the inside outward or the outside inward (depending upon other considerations). Typically, the construction of a heated glove begins with an inner liner 702 (acting as a fabric carrier which has a heating element configured therein, heating element not shown). Outside of the inner liner 702 is typically a void 704, defined as the space between inner liner 702 and insulation layer 710. It is preferable to have additional layers (further referenced in FIG. 7B) outside the insulation layer to provide further environmental protection of the insulation layer 710 and a inner layer 702.

As previously noted, a heating element configured in the inner layer 702 is typically configured on the top of the hand (similar to that illustrated in FIG. 1). More particularly, the heating element of the inner liner 702 is preferably configured so that conductive wires (not shown) can run up to the tip of each finger.

Turning to FIG. 7B, a closer cross section view of the layers of a heated glove 750 (similar to the heated glove 700) illustrates greater detail of the respective layers and components. Outside the insulation layer 710, it is preferable to configure a waterproof layer 712 thereby obstructing environmental elements from reaching the insulation layer 710 and inner liner 702. Outside the waterproof layer 712, it is further desirable to configure an exterior layer 714 of durable fabric (e.g. rugged nylon) to resist wear and tear on the heated glove 750.

As further illustrated, conduits 706A and 706B are in electrical communication with the heating element (not shown) configured upon the inner layer 702 and also are in electrical communication with a power source 708. Similar to the exterior layer 714, it is preferable to configure a cover 716 to protect the power supply 708 from environmental elements. When electricity from power source 708 is transmitted through the textile based heating element configured upon the inner liner 702, heat is generated and substantially contained inside insulation layer 710, thereby heating the inner liner 702.

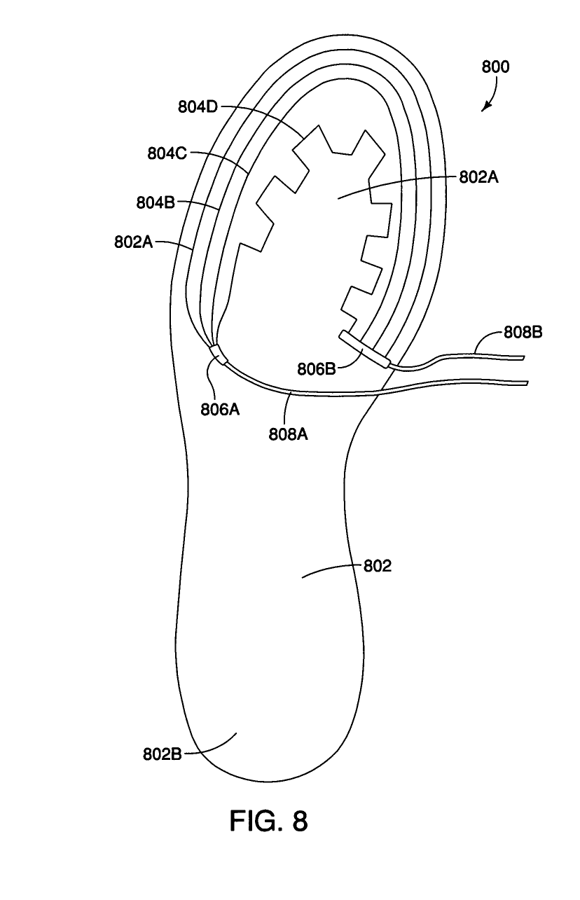

In FIG. 8, a heated footbed 800 is illustrated comprising of similar components of the previously disclosed heated glove of FIG. 1. More particularly, heated footbed 800 comprises an insole 802 having a toes end 802A and heel end 802B, with conductive wires 804A through 804D preferably configured in the toes end 802A of the insole 802. Conductive wires 804A through 804D are electrically coupled to a power source (not shown) through conduits 808A and 808B. It is preferable to utilize electrical connectors 806A and 806B to connect the conductive wires 804A through 804D, respectively, to conduits 808A and 808B. Utilization of such electrical connectors 806A and 806B (e.g. crimp style connectors, soldered connections or other conventional electrical connection) thereby provide a secure mechanical coupling and electrical communication. It is further noted that as illustrated, conductive wire 804D is optionally configured to have a pseudo square sinusoidal block pattern to increase the length of the electrical path and cover greater surface area in the toes end 802A of the heated footbed 800.

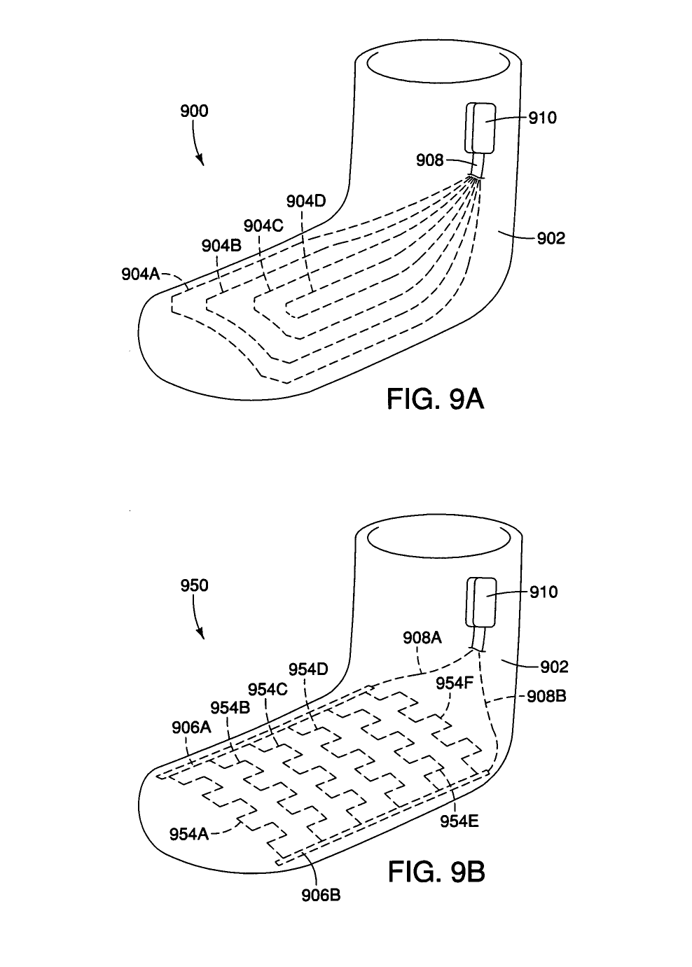

FIGS. 9A and 9B illustrate a heated sock 900 and a heated sock 950, respectively, comprising of generally similar components as the previously disclosed heated glove of FIG. 1 and heated footbed of FIG. 8. More particularly, heated sock 900 and heated sock 950 comprise a sock structure 902 with one or more conductive wires 904A through 904D coupled to a power supply 910 with one or more conduits 908.

It is further noted that conductive wires 904A through 904D can be configured with a lengthwise pattern along the top of the sock structure 902 as illustrated in FIG. 9A, below the foot (not shown), around the circumference of the foot (not shown), or a combination thereof (not shown). As depicted in heated sock 950 in FIG. 9B, the one or more conductive wires 954A through 954D can be desirably configured to have a substantially transverse pattern rather than the substantially longitudinal pattern of the heated sock 900 of FIG. 9A. Not unlike other embodiments of heated articles, the placement and direction of the conductive wires stitched into the fabric carrier is dependent largely on the textile based heating element design (e.g. number of conductive wires, resistance, etc.), length of the textile based heating element, wiring scheme and power supply specifications.

Similar to other embodiments of the textile based heating element disclosed earlier, heated sock 900 and heated sock 950 can be manufactured such that the textile based heating element is coupled to a power source (as shown in FIGS. 9A and 9B) or otherwise coupled to an exterior power source (not shown).

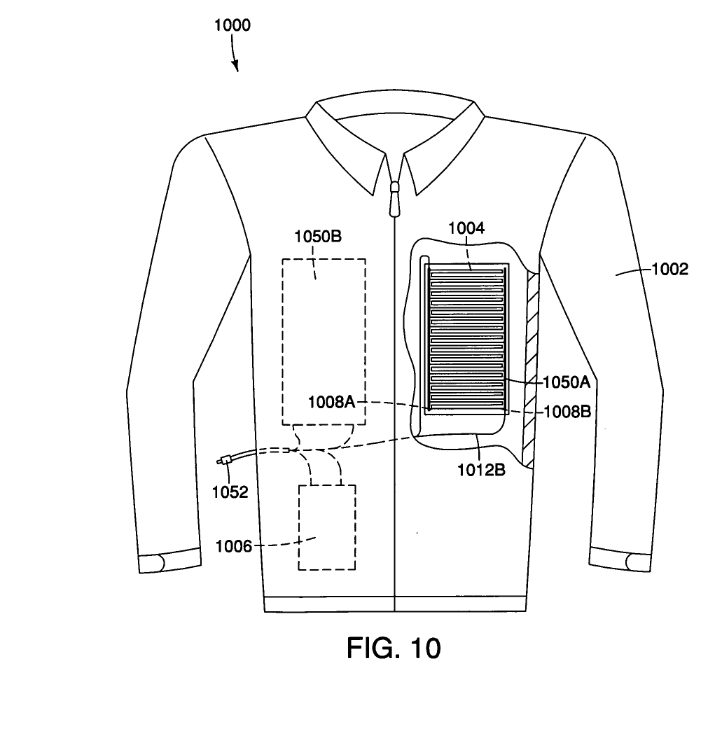

FIG. 10 illustrates a heated jacket 1000 comprising of generally similar components as the previously disclosed heated glove of FIG. 1, heated footbed of FIG. 8 and heated socks of FIGS. 9A and 9B. More particularly, heated jacket 1000 comprises a jacket structure 1002 with terminals 1008A and 1008B in electrical coupling with one or more conductive wires 1004 and conduits 1012A and 1012B, respectively. Conduits 1012A and 1012B are also coupled to power supply 1006 thereby supplying electricity to the one or more conductive wires 1004.

As illustrated, conduits 1012A and 1012B are further coupled, in addition to power supply 1006, to an external power receptacle 1052. The external power receptacle 1052 as illustrated comprises a quick disconnect electrical connector intended to plug into a corresponding quick disconnect connector (not shown) in electrical communication with an external power source (not shown).

One example of such an external power source is a battery charger (not shown) suitable for charging power source 1006. It is further desirable that such a battery charger (not shown) could not only charge power source 1006 but simultaneously have the capacity to transmit electricity through the one or more conductive wires 1004 rendering the heated jacket 1000 operational during charging. Other examples (not shown) of such an external power source comprise convenient direct current power sources such as an automobile 12V power source (e.g. cigarette lighter) or a power harness configured in an aircraft cockpit. Likewise, cell phone chargers or other common electronic power supplies can be configured as a suitable external power source.

As further illustrated in FIG. 10, a heating element 1050A is comprised of one or more conductive wires 1004 and conduits 1012A and 1012B, representing a modular approach to heat generation in garments. Other heating elements such as a heating element 1050B can be configured as desirable in any given garment or equipment application. Here, heating element 1050A is situated on one side of the front of the jacket structure 1002, while heating element 1050B is correspondingly situated on the other side of the front of the jacket structure 1002. Other heated elements (not shown) can be configured as desired in other locations of the jacket structure 1002 such as the back or shoulder areas.

While heating element 1050A is illustrated to have a substantially vertical configuration of the one or more conductive wires 1004 with a pattern similar to other embodiments disclosed. Alternatively, one or more conductive wires 1004 can also be configured to have a substantially horizontal configuration of the textile based heating element (not shown), or other orientation and pattern, to fit and optimize the one or more conductive wires 1004 into the desired area for heating.

During the manufacturing process, heating elements 1050A and 1050B can be manufactured independent of the jacket structure 1002, thereby enjoying supply and cost efficiencies if desirable. With minimal installation procedures, namely inserting and securing (e.g. Velcro attachment, stitching, adhesive, stapling, rivoting, clipped, etc.) the heated elements 1050A and 1050B into the jacket structure 1002, practically any garment or equipment can be configured with a heating apparatus.

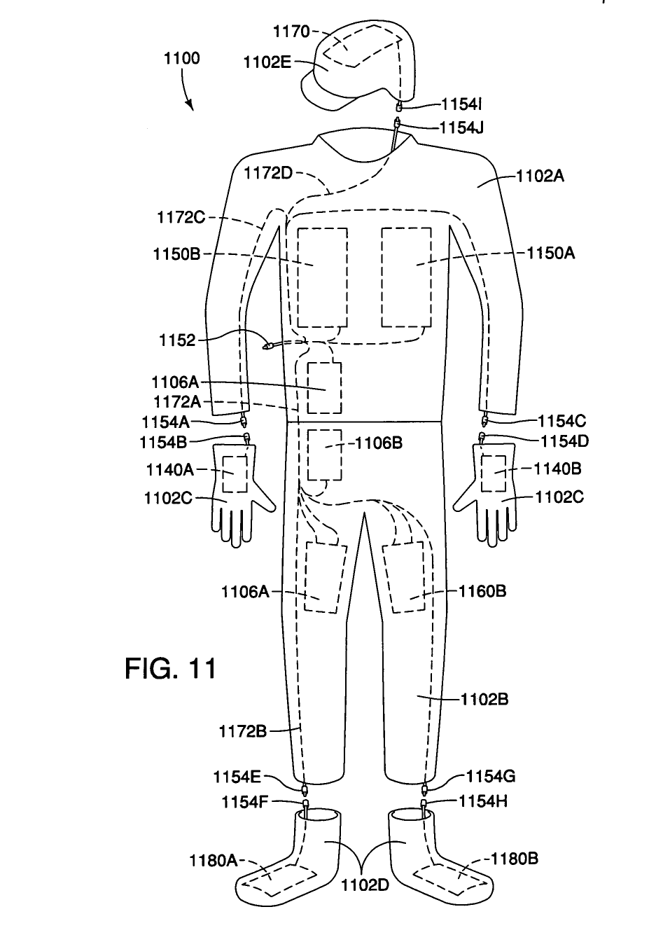

If several articles of clothing or articles of equipment are anticipated to be manufactured, it is preferable to design standard heating elements (such as heating elements 1050A and 1050B) and standard power sources (such as power source 1006) having standardized combinations thereof. Standardization of such combined components of heating apparatus significantly aids in the new design of heated articles of clothing and heated articles of equipment, since the requirement for complex electrical calculations and testing with each new article developed and manufactured can be minimized. An approach to such standardization of components is shown in FIG. 11.

FIG. 11 illustrates a heated clothing system 1100 comprising of various heated articles of clothing such as a heated shirtwear 1102A, a heated legwear 1102B, a heated handwear 1102C, a heated footwear 1102D and a heated headwear 1102E. Generally speaking, the various heated articles of clothing illustrated follow configurations previously discussed in other illustrations and descriptions of heated articles of clothing.

More particularly, heated shirtwear 1102A substantially parallels the jacket design previously discussed in FIG. 10, with a heating element 1150A and a heating element 1150B both coupled to a power source 1106A, all of which are further coupled to a power receptacle 1152. Likewise, heated legwear 1102B is similarly configured to heated shirtwear 1102A, comprising of a heating element 1160A and a heating element 1160B, each situated on the thighs of the heated legwear and each coupled to a power source 1106B. Heated handwear 1102C comprises a heating element 1140A coupled to a power receptacle 1154B and a heating element 1140B coupled to a power receptacle 1154D. Heated footwear 1102D comprises a heated element 1180A coupled to a power receptacle 1154F and a heated element 1180B coupled to a power receptacle 1154H. Heated headwear 1102E comprises a heating element 1170 coupled to power receptacle 11541 through conduit 1172D.

It is preferable that the heated clothing system 1100 is standardized and modular in nature, such that certain articles can be mixed and matched to other articles. For example, such a heated clothing system 1100 could alternatively comprise of only the heated shirtwear 1102A and the heated legwear 1102B but not the remaining heated articles of clothing.

When designing and manufacturing various heated articles of clothing and heated clothing systems, it can be further preferable to configure one or more conduits that provide power to various articles of clothing and the heating elements thereof. For example, in the heated clothing system 1100 illustrated, conduit 1172A is useful for providing electrical communication between heated shirtwear 1102A and heated legwear 1102B. The implementation of such conduits (such as conduit 1172A) can render benefits of implementing a centralized power source, (such as either power source 1106A or power 1106B providing electricity to multiple articles of clothing). Similarly, with the implementation of both power sources 1106A and 1106B and conduit 1172A, a redundant and longer lasting supply of power can be provided by both power sources 1106A and 1106B.

In such a configuration, it is further preferable to configure power receptacle 1152 to charge both power sources 1106A and 1106B at the same time from a single external connection point (power receptacle 1152). Preferably, such an external power source (not shown) can also provide sufficient electricity to operate heating elements 1150A, 1150B, 1160A and 1160B while power sources 1106A and 1106B are being charged. Similarly, additional conduits 1172B and 1172C can be configured to provide sufficient charging power or electric current to supply other heated articles of clothing such as heated handwear 1102C, heated footwear 1102D or heated headwear 1102E.

Where two heated articles of clothing are adjacent to one another and are in electrical communication with one another, it is preferable to utilize selectable connectors (e.g. quick disconnect electrical connections) such that the electrical communication can be easily detached and re-attached. As illustrated, heated handwear 1102C and heated headwear 1102E can be readily detached or re-attached to heated shirtwear 1102A through selectable connectors 1154A, 1154B, 1154C and 1154D and selectable connectors 11541 and 1154J, respectively. Likewise, heated footwear 1102D can be readily detached or re-attached to heated legwear 1102B through selectable connectors 1154E, 1154F, 1154G and 1154H.

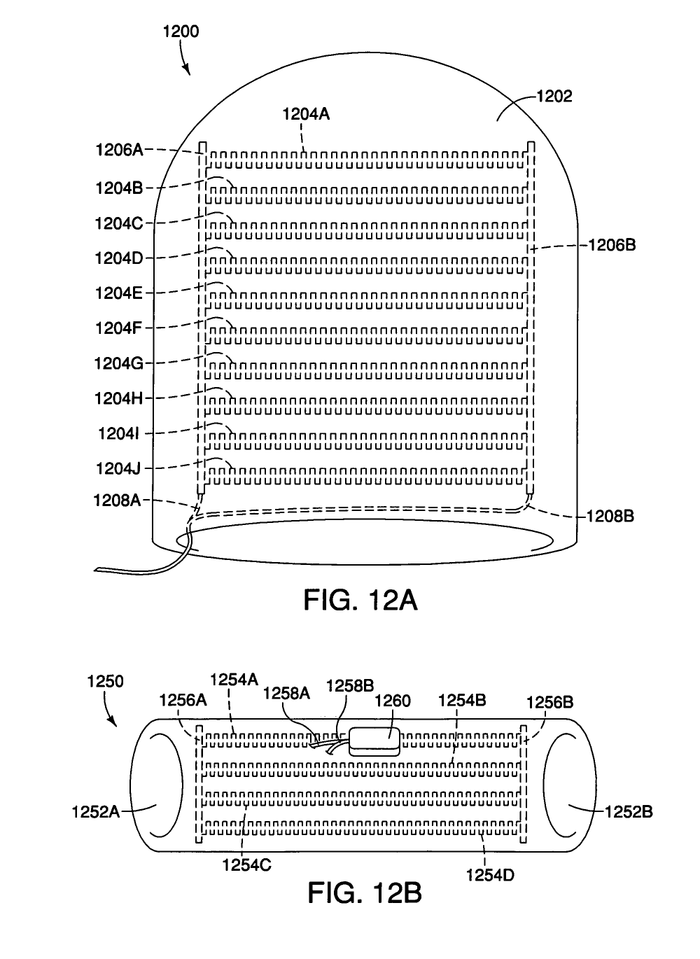

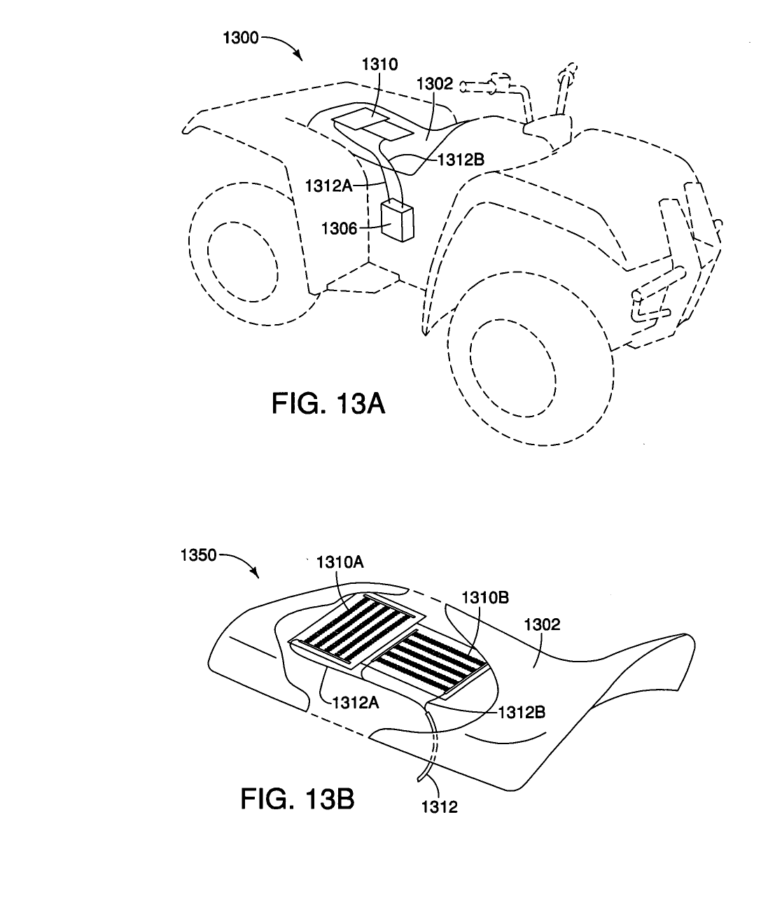

It is understood that depending upon the intended use and articles of clothing chosen, heated clothing systems disclosed can be manufactured as articles of clothing intended to be worn as a liner or underneath other articles (e.g. underwear), or alternatively can be manufactured as clothing worn on as outerwear (e.g. space suit, military uniform, hunting gear, etc.). In this regard, the heated clothing system 1100 and heated articles of clothing and articles of equipment illustrated herein utilizing a textile based heating element are not restricted to any particular environment, usage or function. For example, FIGS. 12A, 12B and 13 exhibit other diverse embodiments of the present invention in the context of sports and recreational equipment.

FIG. 12A illustrates a heated mitt 1200, an electrically heated version of a traditional warming mitt used by professional football linemen in cold weather. Heated mitt 1200 generally follows the topics disclosed of the heated glove of FIG. 1, the heated footbed of FIG. 8, the heated socks of FIGS. 9A and 9B and the heated shirt of FIG. 10. More particularly, heated mitt 1200 comprises a mitt structure 1202 with one or more conductive wires 1204A through 1204J electrically coupled to an external power source (not shown) through one or more conduits 1208A and 1208B. As noted in earlier discussions, the conductive wires 1204A through 1204J could be configured in alternate orientations or patterns (e.g. circumferential rather than parallel routing, horizontal rather than vertical pattern, etc.) depending upon the particular application.

FIG. 12B illustrates a heated handwarmer 1250, an electric heated version of a traditional handwarmer used on the uniform of professional football quarterback in cold weather. Heated handwarmer 1250 generally follows the topics disclosed of the heated glove of FIG. 1, the heated footbed of FIG. 8, the heated socks of FIGS. 9A and 9B, the heated shirt of FIG. 10 and the heated mitt of FIG. 12A. More particularly, heated handwarmer 1250 comprises a tubular structure having openings 1252A and 1252B. Openings 1252A and 1252B are intended for a human hand (not shown) to be inserted at each opening thereof for a brief period of time to exchange heat between the inserted hand and the heated handwarmer 1250 or between the hands thereof.

As this article of equipment is typically worn on the front or back of a football quarterback's uniform, it is of significant advantage to utilize one or more conductive wires 1254A through 1254D forming a heating apparatus rather than traditional prior art heating apparatus that is typically more bulky, heavier and less flexible. Terminals 1256A and 1256B are in electrical communication with conductive wires 1254A through 1254D and are electrically coupled to a power source 1260 with one or more conduits 1258A and 1258B. Such a power source could also be an external receptacle (not shown) as disclosed in earlier discussed embodiments.

The conductive wires 1254A through 1254D are preferably configured in a manner such as that illustrated with a longitudinal parallel pattern. In a like fashion to other articles and discussions above, the conductive wires 1254A through 1254D could be configured in alternate orientations or patterns (e.g. wrapped around the inner or outer circumference of the tubular structure 1252, transverse patterns, etc.) depending upon the desired location of heat generation.

FIG. 13A illustrates a heated seat 1300 for an all terrain vehicle. Discussion and design of the heated seat 1300 generally follows the embodiments previously discussed. The heated seat comprises a seat structure 1302 having a heating element 1310 contained within or secured to seat structure 1302. Heating element 1310 is electrically coupled to a power source 1306 (e.g. a standard 12V motorcycle battery) through conduits 1312A and 1312B. While not illustrated, switches or other controls (not shown) can be configured in conduits 1312A or 1312B to control the transmission of electricity through the heating element 1310.

Turning to FIG. 13B, a heated seat 1350 is illustrated, providing a closer view of a similar heated seat 1300 of FIG. 13A. Heating elements 1310A and 1310B are comprised of one or more conductive wires (not numbered) that are electrically coupled to one or more conduits 1312A and 1312B. While the heating elements 1310A and 1310B are separate circuits, such circuits can also be combined into a single circuit or a larger plurality of circuits as desired. Likewise, the conductive wires and other components such as terminals (not numbered) can be configured in alternate orientations or patterns (e.g. a longitudinal parallel pattern or a circumferential pattern, etc.) depending upon the desired location of heat generation.

As can be appreciated, automotive, rail, boat or aircraft seats, along with other seats, can be readily retrofitted or manufactured to include the above disclosed textile based heating element and heating apparatus technologies. Portable cushions and seats (e.g. stadium seat cushions) and other also make excellent structures to incorporate the heat apparatus disclosed herein. The textile based heating element and heating apparatus technologies can also be utilized in furniture (e.g. heated sofa), office furniture (e.g. heated chair) or practically any physical structures (e.g. heated pipes, critical devices, etc.) in need of heat or otherwise in need of prevention of freezing.

Additional specifications and operational details for standardized heating elements, articles of clothing and other embodiments can be found within the content of the provisional applications as recited in the first paragraph of this technical disclosure.

### CONCLUSION

The novel approaches described herein for a textile based heating element and its design and manufacture thereof, and heating apparatus incorporating such a textile based heating element, provide several advantages over prior approaches. Embodiments of the present invention provide one or more of the desirable features of reduced weight, increased flexibility, increased durability and increased standardization in the design, manufacture and use of heated articles of clothing and heated articles of equipment. In the foregoing specification, the invention has been described as applicable to heating applications, where the special advantages of the apparatus are very desirable. However the same invention may be applied to other needs where the transmission of electricity is desired, such as power transport or data transmission.

Unless otherwise indicated, all numbers expressing quantities of ingredients, properties such as molecular weight, reaction conditions, and so forth used in the specification and claims are to be understood as being modified in all instances by the term “about” or “approximately.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

The terms “a” and “an” and “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is herein deemed to contain the group as modified thus fulfilling the written description of all Markush groups used in the appended claims.

Preferred embodiments of this invention are described herein, including the best mode known to the inventors for carrying out the invention. Of course, variations on those preferred embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

In closing, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

What is claimed is:

1. An improved heating apparatus comprising:
a textile based heating element, the textile based heating element further comprising of one or more conductive wires stitched into a fabric carrier; and,
a power source coupled to the one or more conductive wires of the textile based heating element, wherein the textile based heating element generates heat upon the transmission of electricity through the one or more conductive wires.

2. The improved heating apparatus of claim 1, further comprising a plurality of terminals to couple the one or more conductive wires to the power source.

3. The improved heating apparatus of claim 1, wherein the one or more conductive wires comprises at least six conductive wires.

4. The improved heating apparatus of claim 1, wherein the fabric carrier is one from the following set of: polyester, nylon, fleece, cotton and wool.

5. The improved heating apparatus of claim 1, wherein the one or more conductive wires comprises a textile yarn further comprising a conductive material.

6. The improved heating apparatus of claim 1, wherein the textile based heating element is coated thereby providing environmental and electrical insulation from the environment.

7. The improved heating apparatus of claim 1, wherein the heating element is coated with a liquid plastic coating thereby providing environmental and electrical insulation from the environment.

8. The improved heating apparatus of claim 1, wherein the heating element is coated with a liquid plastic coating and a vinyl coating thereby providing environmental and electrical insulation from the environment.

9. The improved heating apparatus of claim 1, wherein the power source comprises at least one from the group consisting of: a rechargeable battery, a non-rechargeable battery, a power receptacle, a direct current electric source and an alternating current electric source.

10. The improved heating apparatus of claim 1, wherein the power source comprises a rechargeable lithium ion battery, a switch to selectively control the transmission of electricity from the power source and a meter to display the status of the power source.

11. The improved heating apparatus of claim 1, wherein the power source comprises a power source having a voltage between 7.0 and 7.5 volts.

12. The improved heating apparatus of claim 1, wherein the power source comprises a power source having a voltage between 11 and 15 volts.

13. The improved heating apparatus of claim 1, wherein the power source comprises a power source having a voltage between 22 and 28 volts.

14. The improved heating apparatus of claim 1, wherein not all of the conductive wires of the textile based heating element are coupled to the power source.

15. The improved heating apparatus of claim 1, wherein the one or more conductive wires comprises at least two conductive wires configured in a parallel circuit.

16. The improved heating apparatus of claim 1, wherein the textile based heating element is self fusing at temperatures above 150 degrees Fahrenheit.

17. The improved heating apparatus of claim 1, wherein the improved heating apparatus is incorporated into one from the set consisting of: a glove, a sock, an insole, a vest, a jacket, a shirt, a pair of pants, a hat and a seat.

18. An improved article of clothing or equipment comprising:
a textile based heating element incorporated into an article of clothing or equipment, the textile based heating element comprising of six or more conductive wires stitched into a fabric carrier, wherein the textile based heating element generates heat upon the transmission of electricity through the six or more conductive wires; and,
a battery power source, selectively coupled to the one or more conductive wires of the textile based heating element, thereby providing selective transmission of electricity through the textile based heating element and generation of heat by the textile based heating element.

19. The improved article of clothing or equipment of claim 18, wherein the textile based heating element is self fusing at temperatures above 150 degrees Fahrenheit.

20. The improved article of clothing or equipment of claim 18, wherein the article of clothing or equipment is one from the set consisting of: a heated glove, a heated shirt, a heated vest, a heated jacket, a heated sock, a heated insole, a heated hat and a heated seat.

21. A heated glove, comprising:
a textile based heating element stitched into an inner liner of the heated glove, wherein the textile based heating element is situated along the top of the fingers and top of the hand portions of the inner liner;
a lithium ion rechargeable battery power source having a voltage of 7.0 to 7.5 volts, wherein the lithium ion rechargeable battery power source comprises a switch to selectively control the transmission of electricity from the power source and a meter to display a status of the power source;
wherein the lithium ion rechargeable battery power source is selectively coupled to the four or more conductive wires of the textile based heating element in a parallel circuit, thereby providing selective transmission of electricity causing a corresponding selective generation of heat; and,
wherein the textile based heating element is self fusing at temperatures above 150 degrees Fahrenheit.

22. An improved method of producing a heating apparatus, comprising:
providing a fabric carrier to serve as a physical structure and electrical insulator for the heating apparatus;
providing a conductive yarn for stitching;
stitching the conductive yarn into a fabric carrier to form the one or more conductive wires of a textile based heating element; and,
coupling the one or more conductive wires of the textile based heating element to a power source, thereby providing electrical communication between the textile based heating element and the power source for the transmission of electricity through the one or more conductive wires and generation of heat by the textile based heating element.

23. The improved method of producing a heated article of clothing of claim 22, further comprising the step of:
configuring the textile based heating element with a coating to insulate the textile based heating element from the environment.

24. The improved method of producing a heated article of clothing of claim 22, further comprising the step of:
configuring the textile based heating element with a liquid plastic coating to insulate the textile based heating element from the environment.

25. The improved method of producing a heated article of clothing of claim 24, further comprising the step of:
configuring the textile based heating element with a vinyl coating to insulate the textile based heating element from the environment.

26. An improved method of producing a heated article of clothing, comprising:
providing an inner layer, an insulation layer, a waterproof layer and an exterior layer of the article of clothing;
providing a conductive yarn for stitching;
stitching the conductive yarn into the inner layer to form one or more conductive wires, thereby forming a textile based heating element;
providing a rechargeable battery power source, wherein the power source comprises a switch to selectively control the transmission of electricity from the power source and a meter to display a status of the power source;
configuring an insulation layer around the inner layer;
configuring a waterproof layer around the insulation layer;
configuring an exterior layer to contain the waterproof layer, the insulation layer and the inner liner within the exterior layer; and
coupling the one or more conductive wires of the textile based heating element to the power source as a parallel circuit thereby providing for selective transmission of electricity and generation of heat.

27. The improved method of producing a heated article of clothing of claim 26, further comprising the step of:
configuring the textile based heating element with a coating to insulate the textile based heating element from the environment.
